(19) United States
(12) Patent Application Publication
(10) Pub. No.: US 2007/0042866 A1
(43) Pub. Date: Feb. 22, 2007

(54) Calorie counter for weight lifting

(76) Inventors: Steve Skilken, Columbus, OH (US); Kirt Moritz, Lewis Center, OH (US)

Correspondence Address: STANDLEY LAW GROUP LLP, 495 METRO PLACE SOUTH, SUITE 210, DUBLIN, OH, 43017, US

(21) Appl. No.: 11/204,673

(22) Filed: Aug. 16, 2005

(51) Int. Cl. G06Q 10/00; A63B 71/00

(52) U.S. Cl. 482/8; 705/2

(57) ABSTRACT

An apparatus, device, and method for measuring and displaying the amount of calories expended by a person engaged in weight lifting. The apparatus senses the displacement of a weight through the use of a sensor and a computer translates that displacement into caloric expenditure. A display provides the user with a visual report of the amount of caloric expenditure as well as other fitness parameters of the workout. The cumulative amount of calories expended over a length of time may also be provided to the user. The user can control the information displayed and the operations performed through the user interface. The apparatus and device may allow for more than one user at a time. Audible signals may be generated to inform the user about different fitness parameters.

### TECHNICAL FIELD

The present invention relates generally to an apparatus, device, and method for measuring the amount of calories expended by a person who is performing a physical activity. More particularly, the present invention relates to an apparatus, device and method for measuring and displaying the cumulative amount of calories expended during a weight lifting activity.

### BACKGROUND AND SUMMARY OF THE INVENTION

Providing persons who engage in physical activity with information about the intensity of their workouts has become very popular. Weight lifters, like all athletes, value the ability of knowing the details about different fitness parameters, such as how much weight they are lifting, how many repetitions they have done, and the amount of power they have expended. Fitness parameters like these are important for keeping track of athletic progress and setting workout goals.

The knowledge of how many calories are expended during weight lifting and exercise in general has also become increasingly popular in today's society. For many persons, particularly those engaged in physical activity for weight-loss reasons, personal fitness goals may be set in the form of calories expended. For others, calories expended may simply serve as a guideline for the proper intensity of a workout. For all persons, knowledge of the amount of calories expended allows them to keep better track of their personal performance and fitness goals, and, ultimately, to perform better.

When it comes to weight lifting and weight training, knowing the amount of calories expended through lifting weights is particularly important. For persons who engage in weight lifting for weight loss purposes, the amount of calories expended during a lifting workout may be indicative of how much fat they are burning. Persons who engage in the sports of body building and body sculpting are also particularly concerned with how many calories they are expending. Body builders and body sculptors strive to have muscular bodies and very little body fat. The less fat on a person's body, the more “sculpted” that person's body looks. Since the burning of fat is directly related to caloric expenditure, body builders and body sculptors also place a high value on having accurate knowledge of the amount of calories expended while lifting weights.

Many cardiovascular exercise machines, such as elliptical trainers and treadmills, are provided with electronic monitoring devices that measure and display the amount of calories expended by the user during their use of a particular machine. However, it is much more difficult for a person engaged in weight lifting to gain even a somewhat accurate knowledge of how many calories they have expended by lifting weights. Weights do not contain electronic devices that monitor usage. Since weight lifting does not typically involve continuous activity, like most cardiovascular machines, it is difficult for a lifter to use a “rule of thumb” method and apply an average rate of caloric expenditure to their workout time to determine their caloric expenditure. Furthermore, the inherent nature of weight lifting is the ability of weights of different measure to be transferred from type of equipment to another, and placed in various combinations with each other. An example would be the ability of two 10 lb free weights to be placed on a leg press by themselves or on a barbell with two 50 lb free weights. This interchangeable nature of weights and weight lifting equipment makes it even more difficult for a weight lifter to determine their caloric expenditure. The speed with which a lifter lifts a weight affects the amount of calories burned. Depending on the lifter, this speed may vary greatly. Another factor that makes it difficult to determine caloric expenditure is that the distance a weight is lifted varies greatly depending on the lifter, the amount of weight they are lifting, the type of exercise they are engaging in and personal lifting style. For this reason the only way caloric expenditure can be accurately assessed is if it is calculated based on the distance each weight is lifted each time. This of course is a difficult and time-consuming task for any weight lifter to do. Further compounded with the fact that during a typical weight workout a lifter will use several different types of machines with different amounts of weight, the task of calculating cumulative caloric expenditure becomes virtually impossible.

It is therefore desirable to have an apparatus which can measure the amount of calories expended by a lifter in displacing a weight. It is also desirable to have an apparatus which can measure the cumulative amount of calories expended during a lifting workout involving different weight exercises with various pieces of weight equipment.

The present invention is claimed as an apparatus, device, and method for measuring the amount of calories expended by a person while lifting a weight. The apparatus of the present invention is comprised of a sensor that detects the relative displacement of the weight being lifted, a computer that calculates the amount of calories expended in lifting the weight, and a display that allows the user to see the amount of calories expended. The present invention is also the device that computes and displays the amount of caloric expenditure to a user. The method of determining caloric expenditure during weight lifting through the use of a sensor, computer, and display are also claimed as the present invention.

### BRIEF DESCRIPTION OF THE DRAWINGS

A better understanding of the present invention will be obtained when reference is made to the accompanying drawings, wherein identical parts are identified by identical reference numerals, and wherein:

FIG. 1 is a schematic illustration of the various components of an embodiment of the present invention as associated with a free weight;

FIG. 2 is a schematic illustration of a second embodiment of the present invention as associated with a dumbbell;

FIG. 3 is a schematic illustration of a third embodiment of the present invention as associated with a barbell and squat rack;

FIG. 4 is a schematic illustration of a fourth embodiment of the present invention as associated with a home gym;

FIGS. 5 is a front perspective view of an embodiment of the string sensor of the present invention;

FIG. 6 is a right perspective view of an embodiment of the potentiometric mechanism and infrared system removed from the string sensor of the present invention;

FIG. 7 is a left perspective view of an embodiment of the potentiometric mechanism and infrared system removed from the string sensor of the present invention;

FIG. 8 is a front elevational view of an embodiment of the display console of the present invention;

FIG. 9 is a rear elevational view of an embodiment of the display console of the present invention; and

FIG. 10 is a block diagram illustrating the flow of information within the apparatus of the present invention.

### DETAILED DESCRIPTION

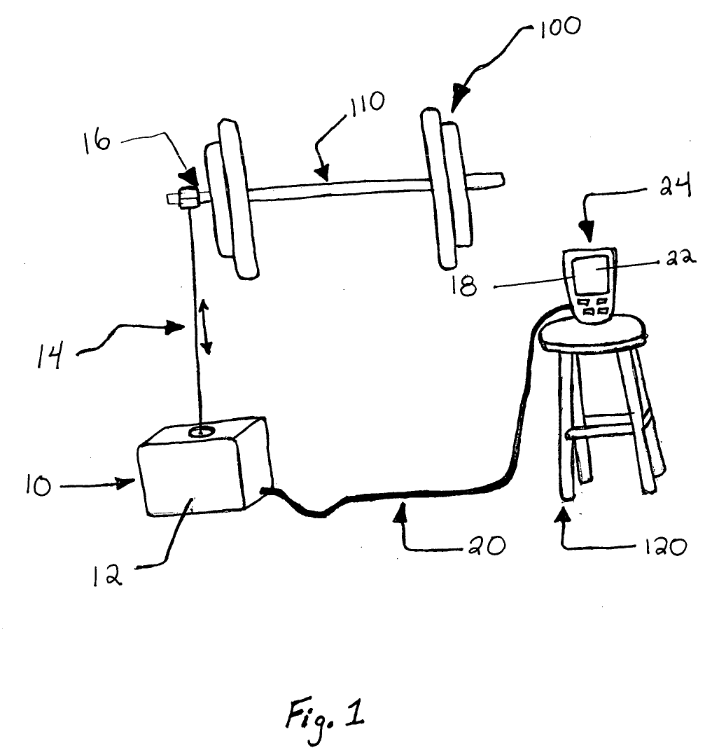

FIG. 1 illustrates an exemplary embodiment of the apparatus of the present invention. In the example illustrated, the apparatus is associated with a free weight 100 that may be lifted by a user. The apparatus includes a string sensor 10, which contains means for sensing and communicating the displacement of a free weight 100 relative to the sensor 10. The string sensor 10 is contained within a sensor housing 12. In a preferred embodiment the sensor housing 12 is made of plastic, although in other embodiments other materials may be used. In many embodiments the components of the string sensor 10 will be sized so that the entire string sensor 10 and sensor housing 12 is portable and can easily be moved to different pieces of weight equipment by a user.

In the illustrated embodiment of FIG. 1 the string sensor 10 is physically connected to the free weight 100 by a string 14 that is attached to the free weight 100 by an attaching means 16. In the illustrated embodiment of FIG. 1 the attaching means 16 is a hook and loop fastener, such as commercially available VELCRO. However, in other embodiments of the present invention the attaching means 16 may be of a different form, including hooks, adhesives, magnets, and strappings made of various materials. In the exemplary embodiment of FIG. 1 the string 14 is attached to the free weight 100 through the bar 110. However, depending on the type of weight being lifted and the preference of the user, in other embodiments of the present invention the string 14 may be attached to any part of a weight or connected part that moves when the weight is lifted. Examples include the weight itself, weight handles, pins, weight plates, and weight bars.

A computer 18 receives signals from the string sensor 10 and performs calculations of various fitness parameters based on those signals. As shown in FIG. 1, the string sensor 10 and computer 18 may be interconnected through a cable 20 that allows the string sensor 10 to communicate signals to the computer 18, and may also provide power to the string sensor 10. The cable 20 may also serve as a power source for the string sensor 10. In a preferred embodiment of the invention the cable 20 is sufficiently long so that the string sensor 10 may be placed at a distance away from the computer 18. However, in other embodiments of the present invention the computer 16 and the sensor 10 may be connected by a much shorter cable, or connected together in one device. In some embodiments of the present invention the string sensor 10 and computer 18 may not be attached by a cable 18. In these embodiments, the computer 18 and string sensor 10 may communicate by other means. Examples of wireless ways in which the computer 18 and string sensor 10 may communicate include infrared or wireless technology, such as BLUETOOTH wireless technology which is commercially available from BLUETOOTH SIG, INC.

Information processed by the computer 18 of the present invention may be communicated to a user through a display 22 that is part of a larger display console 24. In the preferred embodiment of the present invention, and as shown in FIG. 1, both the computer 18 and display 22 are contained in the display console 24. However, in other embodiments of the present invention the computer 18 may be located outside of the display console 24. For example, the computer 18 may be contained within the sensor housing 12 along with the string sensor 10, and may communicate to the display console 24 through a cable or wireless means. In other embodiments of the present invention, the computer 18 is contained within the sensor housing 12 and the display 22 is integrated into the outside of the sensor housing 12. In this embodiment of the present invention, the invention consists of one portable unit, and there is no separate display console 24.

In the preferred embodiment of the present invention the display console 24 is portable and can be easily transported by the user. As shown in the illustrative embodiment of FIG. 1, the display console 24 may be placed on a stand 120 or placed in another location in the vicinity of the user as desired. In a preferred embodiment of the present invention the display console 24 is located near the user and is positioned so that the display 22 may be easily seen by the user. In some embodiments of the present invention the display console 24 may be mounted on a weight, weight machine, or other structure in the vicinity of the user so that it may be easily viewed by the user while they lift the weight. This may be done by placing the display console 24 in a console holder 26 located on a machine. In other embodiments of the present invention the display console 24 may be mounted through the use of straps, magnets, hooks, hook and loop fasteners, adhesives, or other mounting means.

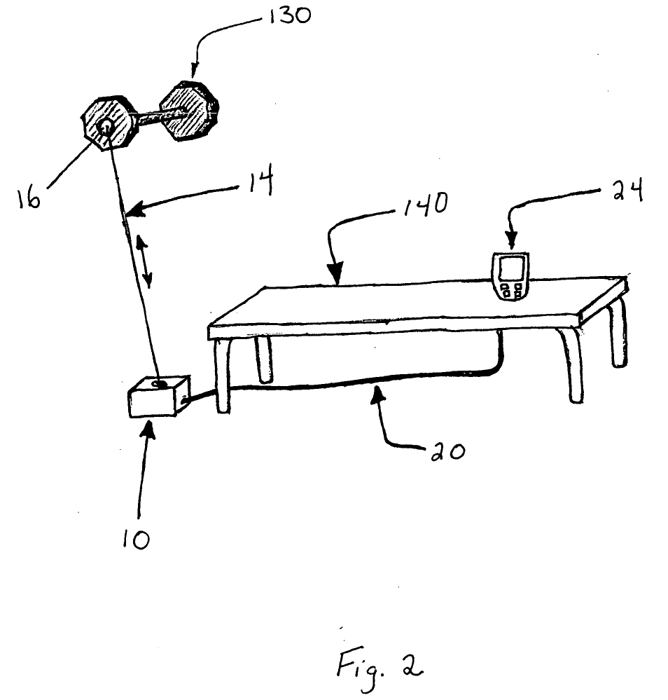

FIG. 2 illustrates an embodiment of the present invention as associated with a dumbbell and a weight bench. The string sensor 10 is located on the floor at the base of the weight bench 140. The attaching means 16 for the string is a magnet that has been placed onto the side of the dumbbell 130.

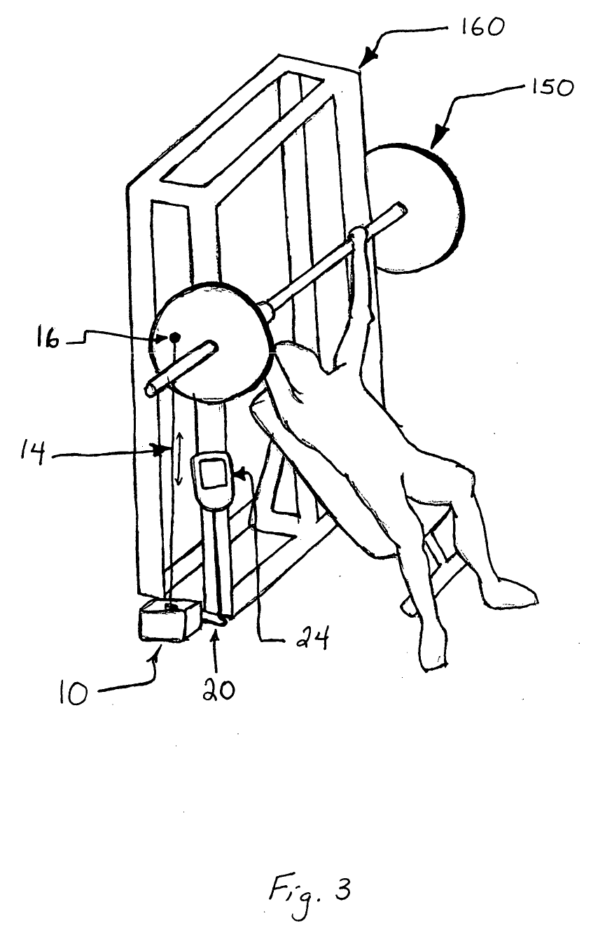

In the schematic illustration of FIG. 3 the present invention is associated with a barbell 150 and a squat rack 160. The string sensor 10 is located at the based of the squat rack 160 and the string 14 is attached to the bar of the barbell 160. The attaching means 16 is a magnet that has been placed onto the side of the barbell 150. The display console 24 is mounted to the side of the squat rack 160.

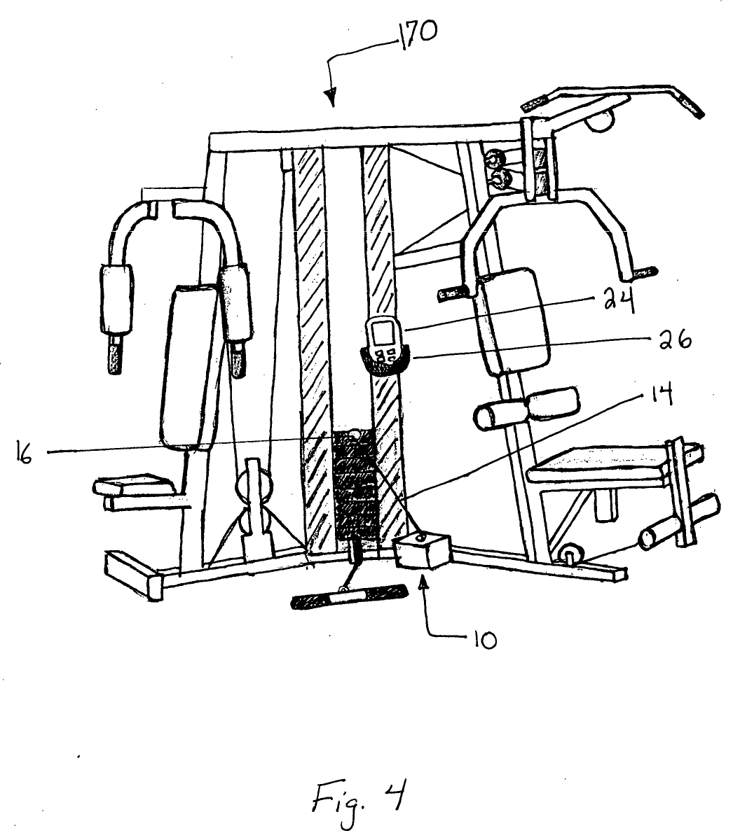

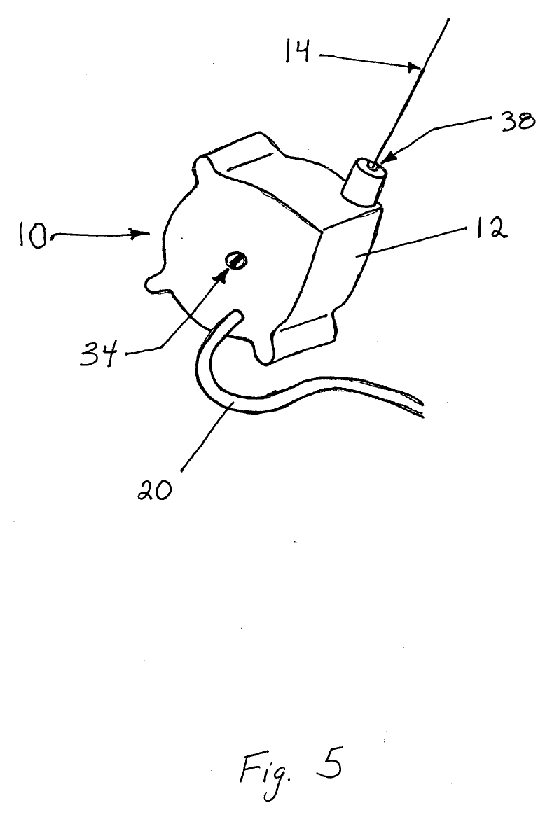

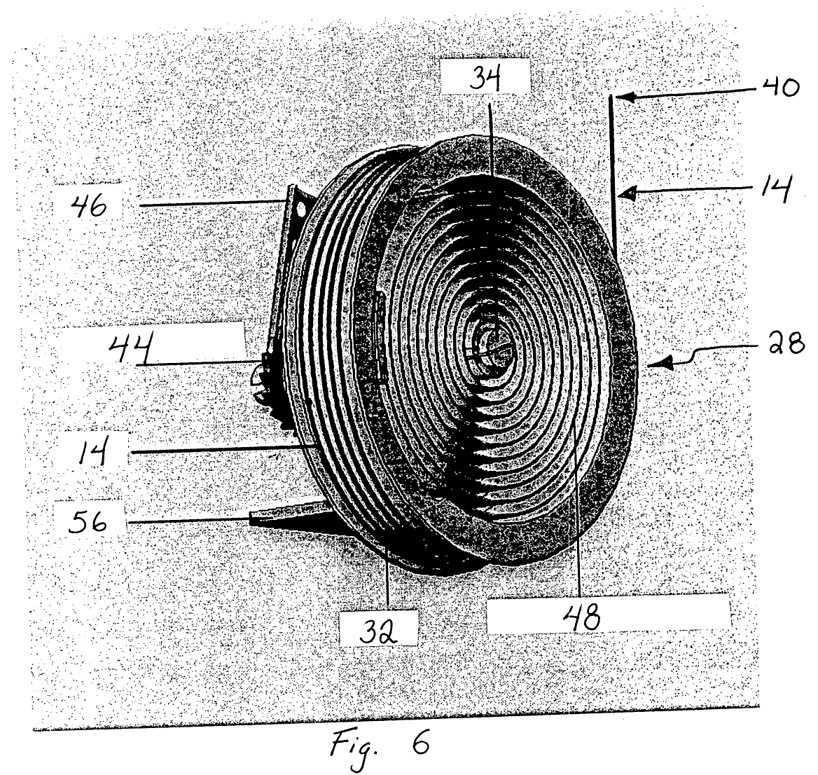

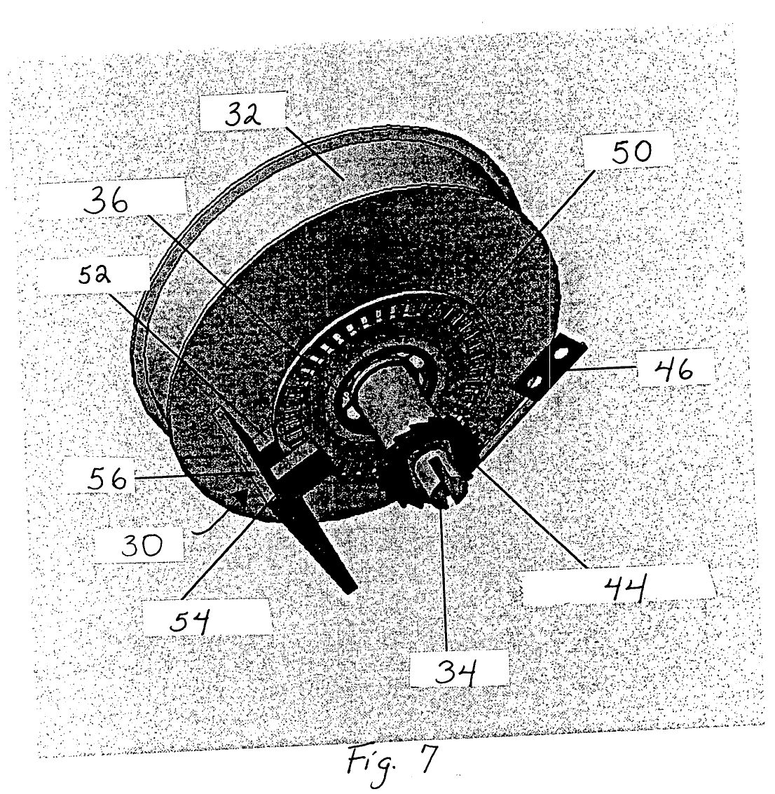

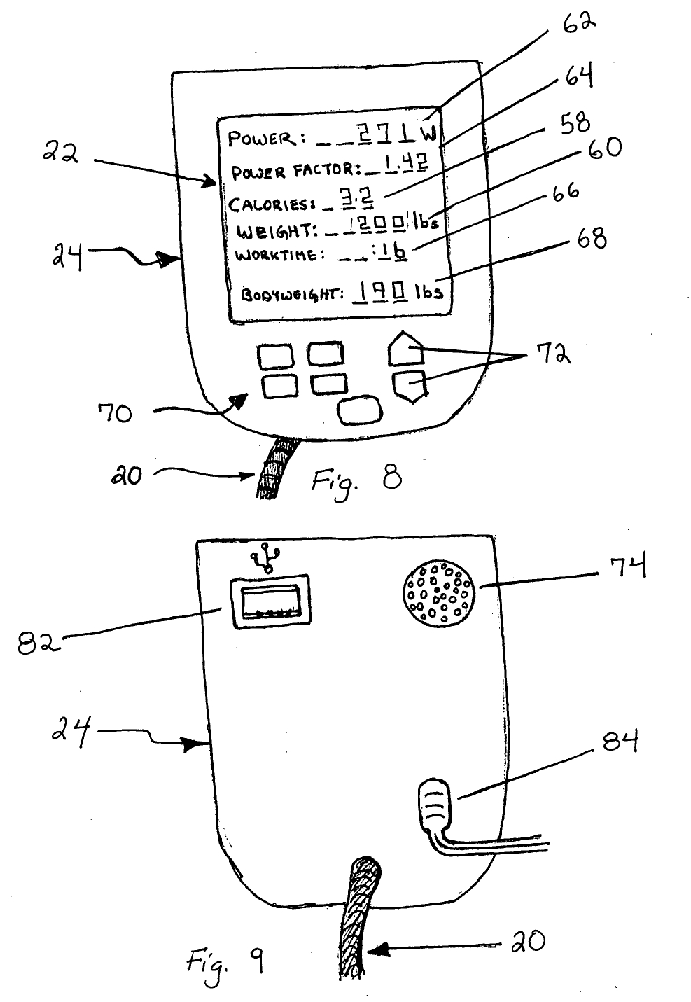

In the schematic illustration of FIG. 4 the present invention is associated with a home gym 170. The string sensor 10 is located at the base of the home gym 170 and the display console 24 is located in a console holder 26 which as been attached to the home gym 170. The attaching means 16 of the string is a magnet. In the illustrative embodiments of FIG. 4 there is no cable 20 connecting the display console 24 to the string sensor 10.

The present invention can be associated with various types of exercise equipment other than those illustrated in the exemplary embodiments of FIGS. 1-4. The present invention can be used in association with virtually any type of weight equipment including various home gyms, flex-rod machines weight bars, dumbbells, circuit machines, hydraulic machines, and plate loaded machines.

FIG. 5 is a front perspective view of the string sensor 10 as shown in FIG. 1. In a preferred embodiment, the string sensor 10 includes a potentiometric mechanism 28 and an infrared sensor system 30, which are contained inside the sensor housing 12 and therefore not depicted in FIG. 5. Although in a preferred embodiment the sensor housing 12 has a cylindrical shape similar to the shape of the potentiometric mechanism 28 contained within, in other embodiments of the present invention the sensor housing 12 may have a variety of shapes. For example, the sensor housing may be shaped like a box.

As shown in the perspective view of FIG. 6, in a preferred embodiment of the present invention the potentiometric mechanism 28 is comprised of a reel 32 which is supported on a shaft 34 by bearing mechanisms 36. The shaft 34 is rotatably supported by the sensor housing. As shown in FIG. 5 the shaft 34 may extend through the side of the sensor housing 12. However, in other embodiments the shaft may be supported by other types of support elements. As shown in FIGS. 5 and 6, the string 14 of the string sensor 10 extends through an opening 38 in the sensor housing 12 and is wound around the reel 32. When a sufficient amount of tension is applied to the outer end 40 of the string 14, the reel 32 rotates and the string 14 is unwound from the reel 32. In a preferred embodiment of the present invention, the inner end of the string 14 is attached to the reel 32 to prevent the complete removal of the string 14 from the reel 32. In a preferred embodiment of the present invention, the string 14 is no more than seven feet long and less than a half inch in diameter. However, in other embodiments of the present invention the string 14 may be of a longer length or larger thickness. In a preferred embodiment of the present invention the string 14 is also made out of a material that can support high tension such as multi-strain steel. However, in other embodiments different materials may be used. In some embodiments of the present invention the potentiometric mechanism 28 may include a ratchet wheel 44 and corresponding pawl 46 that ensure that the reel 32 rotates in only one direction while a weight is being lifted.

In a preferred embodiment of the present invention, and as shown in FIG. 6, the reel 32 is spring loaded 48 to allow for automatic retraction. In other embodiments of the present invention different mechanisms may be used for automatic retraction. Automatic retraction allows the present invention to be utilized during weight exercises that involve repetitive motions. An example of this would be the repetitive lifting and lowering of a dumbbell by a user doing an arm curl, the apparatus of which is shown in FIG. 1. When the dumbbell 130 is raised, and moves in a direction away from the string sensor 10, tension is applied on the string 14 which causes the reel 32 to rotate and unwind the string 14. The unwinding of the string 14 continues until the user has raised the dumbbell 130 to its farthest position relative to the string sensor 10. At this point, the amount of tension on the reel 32 is insufficient to rotate the reel 32 any further, but strong enough to prevent the string 14 from being retracted. When the dumbbell 130 is lowered, and the tension on the string 14 is relieved, the reel 32 retracts the string 14. In doing so, it reduces the slack in the string 14. The automatic retraction continues until the dumbbell 130 reaches its closest point relative to the string sensor 10. In a preferred embodiment of the present invention the automatic retraction of the string 14 will cease once the reel 32 has spooled a predetermined amount of string 14. This prevents the string 14 from being completely retracted into the sensor housing 12 and completely spooled around the reel 28. It is also preferable that a certain length of string 14 remain outside of the sensor housing 12 so that it may be easily accessed by the user.

As shown in the perspective view of FIG. 7, the infrared sensor system 30 of the string sensor 10 is comprised of an encoding disk 50, an infrared emitter 52, an infrared sensor 54 that has at least one receiver, and a substrate circuit 56. The encoding disk 50 is attached to one side of the reel 32 in such a way that it rotates at the same speed as the reel 28. The substrate circuit 56 is located over the encoding disk 50 in such a way that the infrared emitter 52 and sensor 54, both of which are attached to the substrate circuit 56 are located on either side of the encoding disk 50. In a preferable embodiment of the present invention, the substrate circuit 56 is a printed circuit board (PCB). However, in other embodiments of the present invention different types of circuits may be used. As shown in FIG. 7, the infrared sensor 54 is located in a position directly across the encoding disk 50 from the infrared emitter 42. In a preferred embodiment, the infrared sensor 44 and emitter 42 should be positioned such that when the encoding disk 50 is rotating the infrared sensor 54 can receive the corresponding pulses of infrared light from the infrared emitter 52. The substrate circuit 56 can then translate these pulses into electronic signals which are sent to the computer 18 to be used for determining the relative displacement of the weight being lifted to the string sensor and the related fitness parameters. In a preferred embodiment of the present invention, the infrared sensor 54 has two receivers that produce two independent signals. Depending on which signal is received first by the computer, the computer is able to determine whether the reel is rotating in a clockwise or counterclockwise fashion. The signals from the infrared sensor are communicated to the computer via a Schmidt circuit, which translates the original signals into square wave signals which may be read by the computer 18. However, in other exemplary embodiments of the present invention different forms of circuitry may be used.

In an exemplary embodiment of the present invention, the string sensor may include an accelerometer instead of a potentiometric mechanism 28 and infrared sensor system 30. In this embodiment, the sensor housing, containing the accelerometer, may be attached to the weight. The accelerometer may communicate data to the computer 18 regarding the movement of the weight while it is being lifted. The computer 18 may then use the data from the accelerometer to calculate the displacement of the weight and the related fitness parameters, such as caloric expenditure.

In a preferred embodiment of the present invention, and as shown in FIGS. 1-4, the string sensor 10 is located below the weight that is being lifted by the user, such as on the ground or otherwise at the base of a piece of weight equipment. However, in other embodiments of the present invention the string sensor 10 may be located in a different direction relative to the weight being lifted. In some exemplary embodiments the string sensor 10 may be mounted to a piece of weight equipment or other structure. The mounting means for attaching the sensor 10 may include magnets, hook and loop fasteners, adhesives, strappings, hooks, clips, or other means. It is preferable that the sensor 10 be attached to a structure that will remain stationary while the user is lifting the weight. This ensures that the sensor 10 will accurately detect the relative displacement of the weight being lifted, and that the invention as a whole can provide the user with accurate information about their weight lifting. Both the squat rack 160 in FIG. 3 and the home gym in FIG. 4 are examples of structures that the string sensor 10 may be attached to.

FIG. 8 is a front elevational view of an embodiment of the display console 24 of the present invention. As shown in FIG. 8, the display 22 is a liquid crystal display (LCD) panel. -However, in other embodiments the display 22 may be a light emitting diode (LED) display, fluorescent panel, or other form of display. In this embodiment several parameters of the user's workout are visually displayed. One of these parameters is the amount of calories expended 58. In a preferred embodiment of the present invention the display 22 will provide the user with the cumulative amount of calories burned during a workout, and not just those expended in lifting a certain weight one time. Other parameters of the user's workout may also be shown on the display include the amount of weight being lifted 60, the power necessary for lifting a weight a certain distance 62, the power factor of the lift 64, the amount of time the user has been lifting weights 66, or the body weight of the user 68. The exemplary values of the parameters shown in FIG. 8 were calculated for a person weighing approximately 190 lbs who lifts a 200 lb one time. Some embodiments of the present invention may visually display information for more than one user at a time.

As shown in FIG. 8, in a preferred embodiment of the present invention the display console 24 may contain a user interface 70. The user interface 70 allows the user to interact with and control the calculations of the computer 18. The user interface 70 may include keys 72 that allow the user to control the calculations of the computer 18, the display of information, and allow different users of the display console to obtain their personal information. For example, the keys 72 may allow a user to input the amount of weight they are lifting, or allow the user to turn the display console 24 on and off. Other embodiments of the present invention may have different types of user interfaces 70 that allow the user to interact with the apparatus through other means. Examples include touch screens, buttons, and keypads.

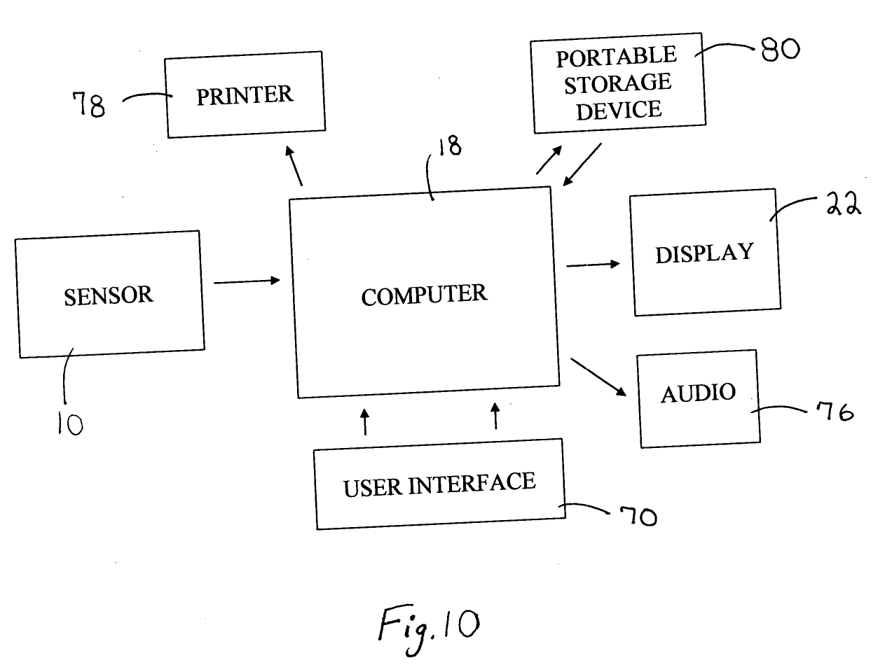

FIG. 9 is a rear perspective view of the display console as embodied in FIG. 8. As shown in FIG. 9, the user interface includes an audio system for generating audible signals. The display console 24 has at least one speaker 74 for providing audible signals to the user, and the computer 18 contains the necessary electronic components for creating audio signals. Although the speaker 74 is located on the backside of the display console 24 in the embodiment of FIG. 7, in other embodiments the speaker may be located elsewhere on the display console 24. Audible signals allow a user to obtain information about their weight lifting parameters without having to look directly at the display console 24. For example, the computer 18 may calculate the proper amount of rest time between repetitions and communicate these rest times to the user using audible signals. This may provide the user with more freedom in movement, allow them to focus more on their weight lifting, and be more conducive overall to the setting and atmosphere of weight lifting.

FIG. 10 is a block diagram of an embodiment of the communication of information involved in the present invention. As depicted, the computer 18 receives information from the string sensor 10 regarding the displacement of a particular weight relative to the string sensor 10. The computer 18 calculates several fitness parameters based that information as well as information which may be entered by the user through the user interface 70. For each weight that is lifted in association with the present invention, the computer 18 needs to know how large the weight is in order to calculate many of the fitness parameters. In a preferred embodiment of the present invention, the user will enter the amount of weight being lifted through the user interface 70. However, it is also possible that the computer will receive information about the amount of weight being lifted through other means. For example, in one embodiments of the present invention, as associated with weight equipment that has a weight stack, the string sensor 10 will be able to determine how much weigh is being lifted, depending on the amount of string 14 located outside of the sensor housing 12 at the beginning of the lift. For example, if each weight on the stack is 2 inches thick and weighs 10 lbs, when the string sensor is associated with a 60 lb lift from the stack, approximately 6 inches of string will be outside the sensor housing 12 at the beginning of the lift. As long as the computer 18 is given information on the amount of weight in one unit of weight on the stack, signals from the string sensor 10 can be used to determine changes in the amount of weight being lifted.

The parameters which may be calculated by the computer 16 include the amount of calories expended and the power generated in displacing the weight. Power generated and calories expended are related by the formula:
K_{cal}=W×0.011833
wherein K_{cal}=kilocalories expended and W=power in watts. Power is determined from the equation:
W=F×((1.35)/((12/D)×t))
where F=the weight lifted in pounds, D=the distance the weight is lifted in inches, and t=the amount of time it takes to lift the weight in seconds. An exemplary embodiment of the present invention will also calculate the “Power Factor” of the lift. This is a measurement of the amount of power generated in a lift per body weight. The formula is:
PF=W/B
where W=power in watts and B is the body weight of the lifter in pounds.

Furthermore, some embodiments of the present invention may calculate additional fitness parameters for the user, including the number of repetitions incurred by the user during the lifting of a specific weight or the rest time between instances of lifting a weight.

In an exemplary embodiment of the present invention, the computer 18 may store information about each instance of a displacement of a weight during a particular time period. For example, the computer 18 may store information during the course of a user's entire weight lifting workout. The computer 18 may then access these stored values in order to calculate cumulative fitness parameters, such as the cumulative amount of calories burned, or the cumulative amount of power generated over a specified time. The computer 18 may also calculate averages of fitness parameters over a particular time period. These may include the average amount of calories expended per minute during a workout, or the average amount of power expended. In some embodiments of the present invention the computer 18 may retrieve information pertaining to past workouts, and use it to provide the user with comparative data regarding past and current workouts. An example would be providing the user with a bar graph showing the user's caloric expenditure per workout over the past month. All fitness parameters and information calculated by the computer 18 may be communicated to the user via the display 22 and audio systems 76 of the display console 24. In some embodiments of the present invention the computer 18 may calculate, store, and retrieve information for more than one user.

In an exemplary embodiment of the present invention the computer may also be connected to a printer 78. The printer 78 may provide the user with a paper copy of the information that has been calculated by the computer 18. For example, the printer 78 may print out summaries of different fitness parameters of the user's workout, or may print out what information is shown on the display 22. The user may control what information is printed through the user interface 60.

In an exemplary embodiment of the present invention the computer 18 may also be able to save and retrieve information from a portable storage device 80. This may allow the user to upload saved data from the present invention onto a different computer, such as a home computer. In addition, different users who wish to share the same display console 24 can access their past fitness parameter data by uploading the data from the portable storage device 80 onto the display console 24. Examples of portable storage devices include floppy disks, hard disks, cds, USB memory sticks, storage disk for the user. In the illustrated exemplary embodiment of FIG. 9, a USB port located on the back of the display console 24 allows a user to upload information onto a USB memory stick.

In an exemplary embodiment of the present invention, the apparatus may consist of more than one string sensor, and one central computer 18 that is separate from and communicates with more than one display console 24 over a network. In this embodiment the string sensors may be integrated into the weight equipment. The central computer 18 has the ability to receive signals from each string sensor 10 when the respective weights are being lifted, and can relay that information to the display console 24 being used by the user of that particular weight.

In a preferred embodiment of the present invention, the string sensor 10 is powered through the cable 20, which receives power from batteries contained in the display console 24. In a preferred embodiment the batteries are rechargeable and are charged by a detachable AC/DC power cord 84 that can be plugged into the display console 24 as necessary. However, in other embodiments of the present Invention the apparatus may be powered by other means. For example, in embodiments where the string sensor 10 and display console are not connected by a cable 20, the string sensor 10 may directly receive power through an AC/DC power cord 84. In other embodiments of the present invention different parts of the apparatus may receive power through different combinations of batteries and power cords.

The preferred embodiments herein disclosed are not intended to be exhaustive or to unnecessarily limit the scope of the invention. The preferred embodiments were chosen and described in order to explain the principles of the present invention so that others skilled in the art may practice the invention. Having shown and described preferred embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

1. An apparatus for measuring the amount of calories expended by a person while moving a weight, comprising:
a sensor for generating at least one signal regarding the displacement of said weight;
a computer for receiving said at least one signal, said computer able to determine the amount of calories expended by said person to induce said displacement of said weight; and
a display for communicating the calculated amount of calories expended to said person.

2. The apparatus as claimed in claim 1, wherein said sensor is comprised of:
a potentiometric mechanism with a rotatable spool of string, wherein when one end of said string is attached to said weight and said weight is displaced in a direction away from said sensor, said rotatable spool of string is unwound from its spool.

3. The apparatus as claimed in claim 2, wherein:
said sensor contains an infrared sensor system, where said infrared sensor system is comprised of an encoding disk, infrared emitter, and an infrared sensor.

4. The apparatus as claimed in claim 1, wherein:
said computer is able to calculate the cumulative amount of calories expended by said person over a pre-determined period of time.

5. The apparatus as claimed in claim 1, wherein:
said computer is able to calculate additional fitness parameters using said at least one signal from said sensor.

6. The apparatus as claimed in claim 1, further comprising:
an interface, said interface having means for the direction of operations by said computer and display of visuals by a user who may or may not be said person, and
a display console, said display console housing said display and said interface in a single, portable unit.

7. The apparatus as claimed in claim 6, wherein:
said interface further comprises means for entering data.

8. The apparatus as claimed in claim 2, further comprising:
a means for mounting said sensor to a structure.

9. The apparatus as claimed in claim 5, wherein:
said computer is adapted to calculate, store, and display fitness parameters for more than one person.

10. The apparatus as claimed in claim 6, wherein:
said string sensor and said display console are connected by a cable.

11. The apparatus as claimed in claim 2, wherein:
said string is made of multi-strain steel.

12. A device for calculating the amount of calories expended by a person to lift a weight, comprising:
a computer for receiving signals regarding the displacement of said weight by said person, said computer able to calculate the amount of calories expended by said person to displace said weight;
a display for visually communicating said amount of calories expended to said person.

13. The device of claim 12, further comprising:
an interface, said interface having means for the direction of operations by said computer by a user who may or may not be said person.

14. The device of claim 12, further comprising:
an audio system controlled by said computer, wherein said audio system generates audible signals for said person.

15. The device of claim 13, wherein:
said computer and said display are housed together in a display console, said display console having said interface located on its outer surface, said display console being of a size that allows for portability by a user who may or may not be said person.

16. The device of claim 12, wherein:
said computer can calculate additional fitness parameters related to the displacement of said weight.

17. The device of claim 13, wherein:
said computer can calculate, store, and retrieve fitness parameter information for more than one user.

18. The device of claim 16, wherein:
one said additional fitness parameters is the power generated from displacing said weight.

19. The device of claim 18, wherein:
one said additional fitness parameters is the ratio of the power generated from displacing said weight to the body weight of said person.

20. A method for measuring the amount of calories expended by a person in moving a weight, comprising the steps of:
providing said weight for said person to lift,
measuring the distance said weight was displaced by said person,
calculating the power required for said weight to be displaced said distance by said person,
calculating the amount of calories expended by said person to generate said power, and
providing means for communicating said amount of calories expended to a user who may or may not be said person.
